(19) United States
(12) Patent Application Publication
(10) Pub. No.: US 2026/0266368 A1
(43) Pub. Date: Sep. 10, 2026

(54) SHIFTING APPARATUS

(71) Applicant: KABUSHIKI KAISHA TOKAI-RIKA-DENKI-SEISAKUSHO, Niwa-Gun, Aichi (JP)

(72) Inventors: Makoto YAMAMOTO, Niwa-gun, Aichi (JP); Yutaka INAMURA, Niwa-gun, Aichi (JP); Takuya WATANABE, Niwa-gun, Aichi (JP); Koji KOBAYASHI, Niwa-Gun, Aichi (JP)

(73) Assignee: KABUSHIKI KAISHA TOKAI-RIKA-DENKI-SEISAKUSHO, Niwa-Gun, Aichi (JP)

(21) Appl. No.: 18/881,424

(22) PCT Filed: Jul. 12, 2023
(86) PCT No.: PCT/JP2023/025738

§ 371 Date: Jan. 6, 2025

(30) Foreign Application Priority Data
Jul. 13, 2022 (JP) 2022-112621

(51) Int. Cl. F16H 59/12

(52) U.S. Cl. CPC F16H 59/12

(57) ABSTRACT

A shifting apparatus includes a shift panel serving as a shift selection unit and plural LEDs serving as illumination means. The shift panel enables selection of shift positions by contact of a finger of an occupant of a vehicle. Plural selection regions are disposed in an operating region of the shift panel. A shift range of a transmission of the vehicle is changed when the occupant finger makes contact with the operating region and selects one of the shift positions. When the occupant finger makes contact with the operating region, the LEDs illuminate the operating region and clearly show the selection regions.

### TECHNICAL FIELD

The present disclosure relates to a shifting apparatus that enables selection of a shift position.

### BACKGROUND ART

In an entry apparatus described in German Patent Application Publication No. 102014009355, functional depressions are touched and a shift range of an automatic transmission is changed.

There is concern that this automatic transmission may be changed to a shift range mistakenly when positions of the functional depressions cannot be discerned.

### SUMMARY OF INVENTION

### Technical Problem

The present disclosure provides a shifting apparatus that may inhibit mistaken selection of a shift position.

### Solution to Problem

A shifting apparatus according to a first aspect of the present disclosure includes: a shift selection unit that enables selection of respective shift positions by contact of an operating part, plural selection regions being disposed in an operating region of the shift selection unit, and a shift range of a transmission of a vehicle being changed when the operating part makes contact with the operating region and selects one of the shift positions; and an illumination means that illuminates the operating region and clearly shows the selection regions.

In a shifting apparatus according to a second aspect, in the first aspect, the illumination means illuminates at least a portion of an outer periphery portion of the operating region and clearly shows the selection regions.

In a shifting apparatus according to a third aspect, in the first or second aspect, the illumination means illuminates outer periphery portions of the selection regions and clearly shows the selection regions.

In a shifting apparatus according to a fourth aspect, in the first or second aspect, symbols respectively indicating the shift positions are disposed in the respective selection regions, and the illumination means illuminates the symbols and clearly shows the selection regions.

In a shifting apparatus according to a fifth aspect, in any one of the first to fourth aspects, the illumination means clearly shows, among the plural selection regions, a selection region that the operating part is approaching.

In a shifting apparatus according to a sixth aspect, in any one of the first to fifth aspects, the illumination means varies an illumination state between, among the plural selection regions, a selection region corresponding to a shift range prior to a change of the transmission, and a selection region corresponding to a different shift range from that shift range.

In a shifting apparatus according to a seventh aspect, in any one of the first to fifth aspects, the illumination means illuminates a selection region corresponding to a shift range to which the transmission can be changed.

In a shifting apparatus according to an eighth aspect, in any one of the first to seventh aspects, the illumination means illuminates the selection regions when the operating part is in contact with the selection regions.

### Advantageous Effects of Invention

In the shifting apparatus according to the first aspect, the plural selection regions are disposed in the operating region of the shift selection unit, and each of the selection regions corresponds with a shift position. When the operating part touches a selection region and a shift position is selected, the shift range of the transmission of the vehicle is changed.

The illumination means illuminates the operating region, clearly showing the selection regions. Therefore, contact of the operating part with the selection region that corresponds to a desired shift position is facilitated, and mistaken selection of a shift position may be inhibited.

In the shifting apparatus according to the second aspect, the illumination means illuminates at least a portion of the outer periphery portion of the operating region.

Therefore, the operating region may be made clear, each selection region in the operating region may be made clear, and mistaken selection of a shift position may be inhibited effectively.

In the shifting apparatus according to the third aspect, the illumination means illuminates outer periphery portions of the selection regions, clearly showing the selection regions. Therefore, each of the selection regions may be made clear, and mistaken selection of a shift position may be inhibited effectively.

In the shifting apparatus according to the fourth aspect, the symbols indicating shift positions that correspond with the selection regions are disposed in the selection regions. The illumination means illuminates the symbols, clearly showing the selection regions. Therefore, a selection region to be touched by the operating part and a shift position corresponding with the selection region may be made clear, and mistaken selection of a shift position may be inhibited effectively.

In the shifting apparatus according to the fifth aspect, the illumination means illuminates so as to clearly show, of the plural selection regions, a selection region that the operating part has approached. Therefore, the selection region that the operating part is approaching may be made clear, and mistaken selection of a shift position may be inhibited even more effectively.

In the shifting apparatus according to the sixth aspect, when the operating region is illuminated, an illumination state is varied between the selection region corresponding to the shift range of the transmission and selection regions other than that selection region.

Therefore, the current shift position is made clear, and mistaken selection of a shift position may be inhibited even more effectively.

In the shifting apparatus according to the seventh aspect, the illumination means illuminates so as to clearly show the selection regions that correspond to shift ranges to which the transmission can be changed. Therefore, shift positions that can be selected are made clear, and mistaken selection of a shift position may be inhibited even more effectively.

In the shifting apparatus according to the eighth aspect, when the operating part touches the operating region, the illumination means illuminates the operating region. Therefore, the operating region is illuminated and the selection regions are clearly shown when the operating part is touching the operating region. Thus, mistaken selection of a shift position by the operating part mistakenly touching a selection region may be inhibited effectively.

### BRIEF DESCRIPTION OF DRAWINGS

FIG. 1 is an elevation view showing a shifting apparatus according to a first exemplary embodiment of the present disclosure as seen from a surface side.

FIG. 2A is a sectional diagram showing the shifting apparatus as seen from a lower side.

FIG. 2B is a schematic diagram showing control structures provided at the shifting apparatus.

FIG. 3A is an elevation view showing an illuminated state of the shifting apparatus.

FIG. 3B is an elevation view showing a non-illuminated state of the shifting apparatus.

FIG. 4A is an elevation view showing a shifting apparatus according to a second exemplary embodiment of the present disclosure as seen from a surface side, showing an illuminated state of the shifting apparatus.

FIG. 4B is an elevation view showing a non-illuminated state of the shifting apparatus according to the second exemplary embodiment.

FIG. 5 is an elevation view showing a shifting apparatus according to a third exemplary embodiment of the present disclosure as seen from a surface side.

FIG. 6A is an elevation view showing an illuminated state of the shifting apparatus according to the third exemplary embodiment.

FIG. 6B is an elevation view showing a non-illuminated state of the shifting apparatus according to the third exemplary embodiment.

FIG. 7 is a sectional diagram of principal portions, viewed in a left-and-right direction, showing an alternative example of a shift panel.

### DESCRIPTION OF EMBODIMENTS

Herebelow, an exemplary embodiment of the present disclosure is described in detail with reference to the attached drawings.

### First Exemplary Embodiment

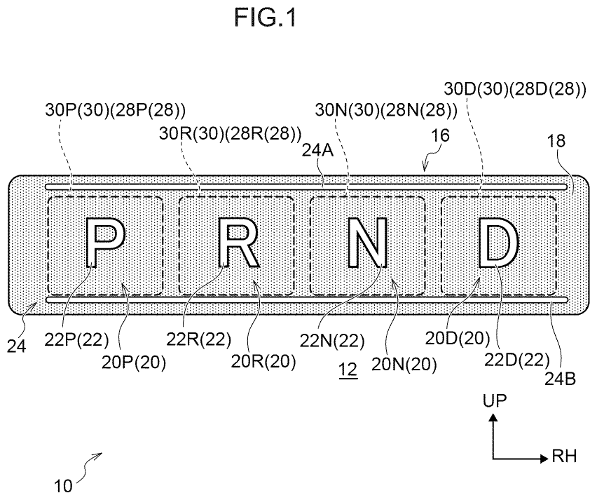

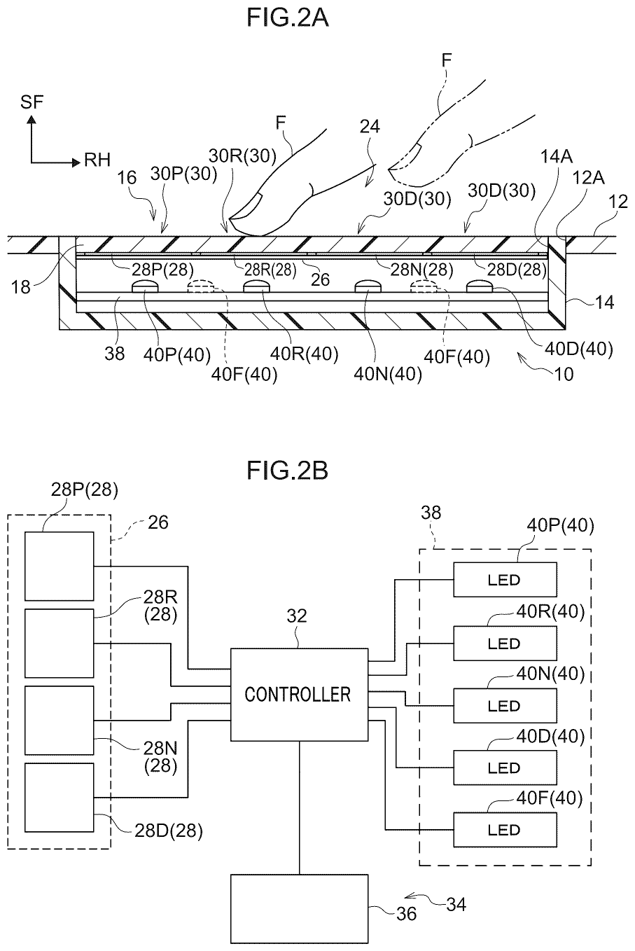

FIG. 1 shows a shifting apparatus 10 according to a first exemplary embodiment of the present disclosure in an elevation view seen from a surface side. FIG. 2A shows the shifting apparatus 10 in a sectional diagram seen from a lower side, and FIG. 2B shows control structures of the shifting apparatus 10 in a schematic structural diagram. In the drawings, the surface side of the shifting apparatus 10 is indicated by arrows SF, rightward of the shifting apparatus 10 is indicated by arrows RH, and upward of the shifting apparatus 10 is indicated by arrows UP.

As shown in FIG. 1 and FIG. 2A, the shifting apparatus 10 is disposed at a vehicle width direction central portion of an instrument panel 12 of a vehicle (a car). The shifting apparatus 10 is disposed at the vehicle width direction inner side of a steering wheel (not shown in the drawings). The surface side, rightward and upward of the shifting apparatus 10 are oriented to, respectively, the rear side, right side and upper side of the vehicle.

The shifting apparatus 10 is provided with a substantially cuboid box-shaped case 14 that serves as an installation body. The case 14 is fixed to the instrument panel 12. The case 14 is long in the left-and-right direction, and a substantially rectangular aperture 14A is formed in the surface side of the case 14, opening the interior of the case 14 to the surface side. A rectangular aperture 12A is formed in the instrument panel 12. The aperture 12A opens to the vehicle rear side. The case 14 is tightly fitted into the aperture 12A and attached. Thus, the interior of the case 14 is open to the rear side through the aperture 12A.

A rectangular plate-shaped shift panel 16 that serves as a selection body and a shift selection unit is disposed at the surface side of the case 14. The shift panel 16 is tightly fitted into the aperture 14A of the case 14. The shift panel 16 closes off the aperture 14A at the surface side of the case 14. The aperture 12A of the instrument panel 12 is closed off by the shift panel 16 and peripheral portions of the aperture 14A of the case 14.

A plate 18 is provided at the surface side of the shift panel 16. The plate 18 is, for example, fabricated of resin and is an electrical insulator. A surface side face of the plate 18 is coplanar with a vehicle rear side face of the instrument panel 12. The surface of the plate 18 (and a frame surface encircling the aperture 14A of the case 14), together with the vehicle rear side face of the instrument panel 12, forms a design surface of a vehicle cabin interior of the vehicle. The plate 18 (the shift panel 16) may be touched by a finger of an occupant (in particular, a driver) of the vehicle (a finger of a hand, which is below referred to as the occupant finger F), which serves as an operating part.

As shown in FIG. 1, plural shift positions 20 are specified at the surface side face of the plate 18. The shift positions 20 include a P (park) position 20P, an R (reverse) position 20R, an N (neutral) position 20N and a D (drive) position 20D. The P position 20P, R position 20R, N position 20N and D position 20D are specified at the surface side face of the plate 18 with a predetermined spacing (equal spacing), in that order from the left side to the right side. Labels 22 that serve as symbols representing the shift positions 20 are disposed at the plate 18. As the labels 22, a “P” (a P label 22P), an “R” (an R label 22R), an “N” (an N label 22N), and a “D” (a D label 22D) are formed at the P position 20P, R position 20R, N position 20N and D position 20D.

A mark 24A and a mark 24B that serve as symbols indicating an operating region 24 are also disposed at the surface side face of the plate 18. The marks 24A and 24B are each formed in a long line shape in the left-and-right direction. The mark 24A is formed in a linear shape at the upper side of the P label 22P, R label 22R, N label 22N and D label 22D, and the mark 24B is formed in a linear shape, which is substantially parallel with the mark 24A, at the lower side of the P label 22P, R label 22R, N label 22N and D label 22D. The operating region 24 is a region surrounded (sandwiched) by the mark 24A and the mark 24B.

Respective regions of the P label 22P, R label 22R, N label 22N and D label 22D and marks 24A and 24B in the plate 18 are optically transmissive, and other regions block light (are optically non-transmissive). Therefore, when the plate 18 is illuminated from a back side face, illumination light is transmitted through the P label 22P, R label 22R, N label 22N and D label 22D and the mark 24A and mark 24B.

An electrode sheet 26 in a rectangular sheet shape, which serves as a detection portion, is attached to the back side of the plate 18 of the shift panel 16. The electrode sheet 26 is electrically insulative and optically transmissive (a transparent sheet), and covers the back side face of the plate 18. Plural electrodes 28 in rectangular thin-film shapes, which serve as detecting means, are provided at a face of the electrode sheet 26 at the side thereof that opposes the plate 18. The electrodes 28 include a P electrode 28P, an R electrode 28R, an N electrode 28N and a D electrode 28D. The P electrode 28P, R electrode 28R, N electrode 28N and D electrode 28D are disposed at the electrode sheet 26, in that order from the left side to the right side as seen from the surface side of the shift panel 16, with predetermined spacings (substantially equal spacings) from one another.

The electrodes 28 are each a transparent electrode with electrical conductivity, employing ITO (indium tin oxide) or the like. It is sufficient if each electrode 28 is a rectangular thin film that is electrically conductive and optically transmissive. The electrodes 28 may employ silver nanowires (AgNW), PEDOT (polyethylenedioxythiophene), CNT (carbon nanotubes) or the like, and the electrodes 28 may be formed as meshes of metal with very fine widths.

Plural regions 30 that serve as selection regions are provided at the surface side face of the plate 18. The regions 30 include a P region 30P, an R region 30R, an N region 30N and a D region 30D. The P region 30P, R region 30R, N region 30N and D region 30D are regions with predetermined ranges surrounding, respectively, the P label 22P, R label 22R, N label 22N and D label 22D in the operating region 24 between the mark 24A and the mark 24B. The P electrode 28P, R electrode 28R, N electrode 28N and D electrode 28D are regions superposed with, respectively, the P region 30P, R region 30R, N region 30N and D region 30D at the surface side face of the plate 18. Therefore, respective positions of the P electrode 28P, R electrode 28R, N electrode 28N and D electrode 28D may be identified (discerned) from the mark 24A and mark 24B.

As illustrated in FIG. 2B, a controller (ECU) 32 that serves as controlling means is provided at the shifting apparatus 10. The controller 32 is provided with a microcomputer, to which a CPU, ROM, RAM, nonvolatile memory (storage) and the like are connected by a bus, and with required functional circuits (none of which are shown in the drawings). The CPU reads programs memorized in the ROM and memory, loads the programs into the RAM and executes the programs. Thus, functions are implemented by the controller 32 in accordance with the programs.

The electrodes 28 of the electrode sheet 26 are electronically connected to the controller 32. A transmission control ECU 36 of a transmission 34 (an automatic transmission) of the vehicle is also connected to the controller 32. The transmission control ECU 36 controls the transmission 34, switching a shift range (transmission range) of the transmission 34 among a P (park) range, an R (reverse) range, an N (neutral) range and a D (drive) range. The current shift range of the transmission 34 is displayed at a predetermined position of the instrument panel 12.

The controller 32 employs the electrodes 28 (the P electrode 28P, R electrode 28R, N electrode 28N and D electrode 28D), functioning as self-induction-type electrostatic capacitance sensors. When the occupant finger F (as depicted by two-dot chain lines in FIG. 2A) approaches one of the electrodes 28, an electrostatic capacitance is produced between the electrode 28 and the occupant finger F. The electrostatic capacitance produced at the electrode 28 changes in accordance with distance and opposing area between the electrode 28 and the occupant finger F. A predetermined electrostatic capacitance is produced by the approach of the occupant finger F, and the electrostatic capacitance changes further when the occupant finger F (as depicted by solid lines in FIG. 2A) makes contact with the surface side face of the plate 18.

The controller 32 detects electrostatic capacitances of the electrodes 28 (voltages that change in accordance with the electrostatic capacitances), and detects whether or not the occupant finger F is approaching the operating region 24 of the plate 18. The controller 32 also detects, from the electrostatic capacitances of the electrodes 28, whether or not the occupant finger F has made contact with any of the regions 30. From the region 30 that the occupant contacts, the controller 32 detects (determines) which of the shift positions 20 has been selected. The controller 32 outputs signals according to the selected shift position 20 to the transmission control ECU 36, and the shift range (transmission position) of the transmission 34 is switched in accordance with the selected shift position 20.

In the shifting apparatus 10, a board 38 (a circuit board) is disposed inside the case 14. The board 38 is formed in a long, narrow, substantially rectangular shape. The board 38 is mounted inside the case 14, substantially parallel with the back side face of the plate 18. Plural LEDs 40 that serve as illumination means are disposed on the board 38. The LEDs 40 include an LED 40P, an LED 40R, an LED 40N, an LED 40D and LEDs 40F. The LEDs 40 (40P, 40R, 40N, 40D and 40F) each may emit white light (light combining the colors R, G and B). Emitted colors and light strengths of the LEDs 40 may be changed.

The LEDs 40 (40P, 40R, 40N, 40D and 40F) respectively oppose the back side face of the plate 18 (the back side face of the electrode sheet 26) to be capable of illuminating predetermined regions in the operating region 24. The LED 40P, LED 40R, LED 40N and LED 40D are capable of illuminating toward, respectively, the P region 30P, R region 30R, N region 30N and D region 30D. The LEDs 40F are plurally provided and are capable of illuminating toward the mark 24A and the mark 24B. In the case 14, required light-blocking means such as light-blocking walls and the like, which are not shown in the drawings, are provided between the back side face of the plate 18 and the board 38, suppressing leakages of illumination light outside the respectively specified regions.

Each of the LEDs 40 (the LED 40P, LED 40R, LED 40N, LED 40D and LEDs 40F) is electronically connected to the controller 32. Lighting of each of the LEDs 40 is controlled by the controller 32. The controller 32 controls lighting of each of the LEDs 40 in accordance with electrostatic capacitances (or changes in electrostatic capacitance) detected by the plural electrodes 28.

Now, operation of the first exemplary embodiment is described.

In the shifting apparatus 10, when the occupant finger F touches one of the regions 30 (the P region 30P, R region 30R, N region 30N or D region 30D) on the shift panel 16 (the plate 18), the shift position 20 corresponding to the region 30 that is touched (the P position 20P, R position 20R, N position 20N or D position) is selected.

That is, in the shifting apparatus 10, when the occupant finger F approaches the shift panel 16 (the plate 18) for a shifting operation, the electrostatic capacitance of one of the plural electrodes 28 increases, and when the occupant finger F makes contact with one of the regions 30 of the plate 18, the occupant finger F further increases (to a maximum) the electrostatic capacitance produced at the electrode 28 of the contacted region 30.

At the controller 32, when a voltage Vc detected by one of the electrodes 28 is at least a threshold value Vth1 specified in advance (Vc≥Vth1), the controller 32 determines that the occupant finger F is in contact with the region 30 corresponding to that electrode 28. If the state in which the occupant finger F is determined to be in contact continues for at least a predetermined threshold duration Tth (for example, 0.5 seconds), the controller 32 determines that the shift position 20 (the P position 20P, R position 20R, N position 20N or D position 20D) corresponding to that region 30 has been selected.

When the controller 32 determines that one of the shift positions 20 has been selected by the occupant, the transmission control ECU 36 changes the shift range of the transmission 34 to the shift range (P range, R range, N range or D range) corresponding to the selected shift position 20. Thus, the shifting apparatus 10 may change the shift range of the transmission 34 of the vehicle in accordance with occupant operations.

In the shifting apparatus 10, when the occupant finger F approaches the operating region 24 of the plate 18 to select a shift position, the electrostatic capacitance produced at the electrode 28 is increased relative to an electrostatic capacitance before the finger F approaches. In the shifting apparatus 10, the plural LEDs 40 (40P, 40R, 40N, 40 and 40F) are mounted at the board 38 inside the case 14. At the shift panel 16, the electrode sheet 26 and the electrodes 28 disposed on the electrode sheet 26 feature translucency, and each of the labels 22 (the P label 22P, R label 22R, N label 22N and D label 22D) and marks 24A and 24B of the plate 18 features translucency.

A threshold value Vth2 is specified in advance to enable determination of when the occupant finger F is approaching the plate 18. When a voltage Vc corresponding to an electrostatic capacitance of the electrodes 28 reaches the threshold value Vth2 (Vth1>Vc≥Vth2), the controller 32 lights up the LEDs 40F in order to illuminate the marks 24A and 24B. The controller 32 also lights up the LEDs 40 (40P, 40R, 40N and 40D) in order to illuminate the regions 30 (P region 30P, R region 30R, N region 30N and D region 30D).

The voltage Vc that is employed at this time may be a maximum value among respective voltages detected from the plural electrodes 28, or a sum of the respective detected voltages from the plural electrodes 28 (or of two adjacent electrodes 28). It is sufficient that the threshold value Vth2 be specified in accordance with the voltage that is employed (the voltage of one of the electrodes 28, the voltage of two adjacent electrodes 28, or the sum of respective voltages of the electrodes 28). The LEDs 40 are lit up so as to emit respective lights of the same color (for example, white).

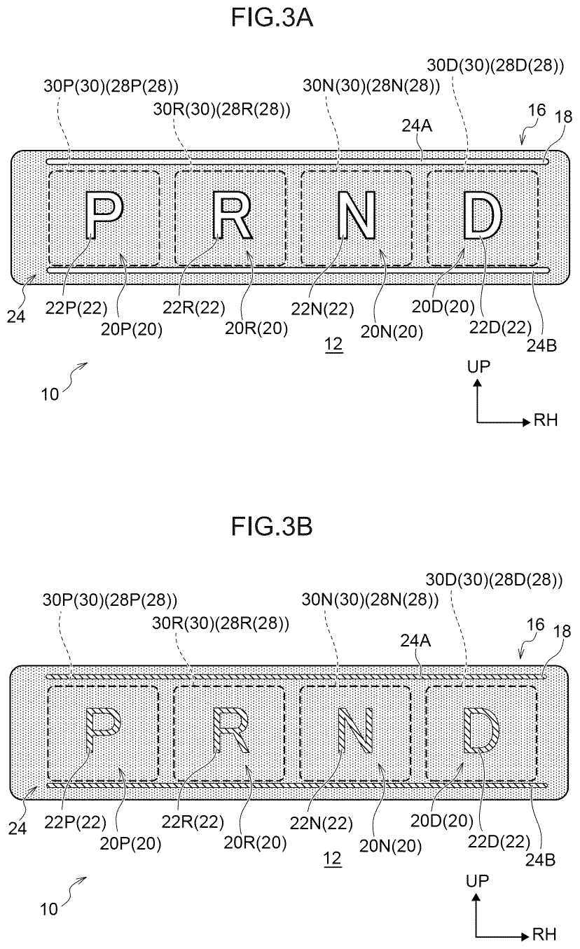

Thus, the shift panel 16 (the plate 18) of the shifting apparatus 10 is illuminated from the back side by the LEDs 40, and each of the labels 22 and marks 24A and 24B is brightened. FIG. 3A shows an elevation view of the shift panel 16 in a state illuminated by the LEDs 40, and FIG. 3B shows an elevation view of the shift panel 16 in a non-illuminated state.

As shown in FIG. 3B, when the LEDs 40 of the shifting apparatus 10 are not lit up, neither of the marks 24A and 24B and none of the labels 22 emit light (light is not emitted).

As a result, if the vehicle exterior is dim and the vehicle cabin interior is dark, the labels 22 and marks 24A and 24B at the shift panel 16 are hard to see.

In contrast, as shown in FIG. 3A, when the LEDs 40 of the shifting apparatus 10 light up, the operating region 24 and each of the regions 30 in the operating region 24 are illuminated. Consequently, even when the vehicle cabin is dark during night or the like, each of the marks 24A and 24B and each of the labels 22 at the shift panel 16 are brightened (clearly shown), and each of the marks 24A and 24B and each of the labels 22 are easy to see.

When the marks 24A and 24B of the shifting apparatus 10 are illuminated, the marks 24A and 24B become bright and each of the regions 30 arrayed between the mark 24A and the mark 24B is made clear. Thus, the P region 30P, R region 30R, N region 30N and D region 30D are easier to discern. In consequence, in the shifting apparatus 10, the shift positions 20 (the P position 20P, R position 20R, N position 20N and D position 20D) may be selected accurately, and mistaken selections of the shift positions 20 may be inhibited effectively.

When the labels 22 (the P label 22P, R label 22R, N label 22N and D label 22D) of the shifting apparatus 10 are illuminated, each of the regions 30 (the P region 30P, R region 30R, N region 30N and D region 30D) becomes bright (is made clear). Thus, when the LEDs 40 light up in the shifting apparatus 10, the shift positions 20 (the P position 20P, R position 20R, N position 20N and D position 20D) may be selected even more accurately, and mistaken selections of the shift positions 20 may be inhibited even more effectively.

Before the occupant finger F touches the shift panel 16, the LEDs 40 of the shifting apparatus 10 illuminate the shift panel 16 from the back side. Therefore, in the shifting apparatus 10, the surface side face of the shift panel 16 is brightened, and the occupant mistakenly touching the regions 30 and mistakenly selecting a shift position may be inhibited effectively.

The LEDs 40 of the shifting apparatus 10 are not lit up in a state in which the occupant finger F has not approached the shift panel 16. Therefore, unnecessary brightening of the vehicle cabin interior due to the LEDs 40 being unnecessarily lit up may be suppressed. In addition, when the occupant causes the finger F to approach the shift panel 16 of the shifting apparatus 10 in order to change the shift position, the LEDs 40 are lit up. Thus, the LEDs 40 may be used to illuminate the shift panel 16 effectively.

In the shifting apparatus 10, the marks 24A and 24B are employed at the shift panel 16 (the plate 18). However, a symbol indicating the operating region 24 may be at least one of the mark 24A at the upper side and the mark 24B at the lower side, or the mark 24A and mark 24B may be formed in a frame shape with their respective ends in the left-and-right direction linked together.

The LEDs 40 of the shifting apparatus 10 emit lights of the same color (white), but the LEDs 40 may emit lights of colors other than white, and one or more of the LEDs 40 may emit light of a different color from the others. For example, the LED 40P, LED 40R, LED 40N and LED 40D may emit lights of white or of amber or the like, and the LEDs 40F may emit lights of blue or the like. As a result, the occupant may clearly recognize the operating region 24 and the regions 30 in the operating region 24.

The LEDs 40 (40P, 40R, 40N, 40D and 40F) of the shifting apparatus 10 light up when the occupant finger F touches the shift panel 16 (when the finger F approaches the shift panel 16). However, this is not limiting; the LEDs 40F may be lit beforehand and the LED 40P, LED 40R, LED 40N and LED 40D may light up when the occupant finger F approaches the shift panel 16.

The shifting apparatus 10 lights up the LEDs 40 conditional on the occupant finger F approaching the shift panel 16. However, brightness of the environment of the shift panel 16 (illuminance on the surface side face) may be made a condition and the shifting apparatus 10 may light up the LEDs 40 when the environment is at a predetermined brightness (a brightness in which the labels 22 cannot be distinctly seen in the non-illuminated state, or the like). The shifting apparatus 10 may also light up the LEDs 40 in conjunction with lighting up of front lights of the vehicle.

The LEDs 40 may light up beforehand in a dark color such as deep green or the like, and when the occupant finger F approaches the shift panel 16, the lighting color may be changed to light up in a more vivid color such as yellow, orange or the like. The LEDs 40 may light up beforehand with a low luminance (brightness), and when the occupant finger F approaches the shift panel 16, may light up so as to be brighter (such that the luminance is higher).

The controller 32 of the shifting apparatus 10 is connected to the transmission control ECU 36 of the transmission 34. Therefore, when the LED 40P, LED 40R, LED 40N and LED 40D of the shifting apparatus 10 are lit up, the region 30 of the shift position 20 that corresponds to the current shift range of the transmission 34 may be set to emit light in a different color from the regions of the other shift positions 20. In the shifting apparatus 10, the regions 30 of the shift positions 20 that correspond to shift ranges to which the transmission 34 can be changed and the regions 30 of the shift positions 20 that correspond to shift ranges to which the transmission 34 cannot be changed may be illuminated with different colors or brightnesses.

For example, the shifting apparatus 10 may light up the LED 40 of the shift position 20 corresponding to the current shift range of the transmission 34 in a vivid color such as orange or the like, and may light up the LEDs 40 of the other shift positions 20 in white or in a dark color (for example, deep green or the like). Further, the shifting apparatus 10 may light up the LED 40 of the shift position 20 corresponding to the current shift range of the transmission 34 with a luminance lower (darker) than a luminance of the LEDs 40 of the other shift positions 20.

### Second Exemplary Embodiment

Now, a second exemplary embodiment is described.

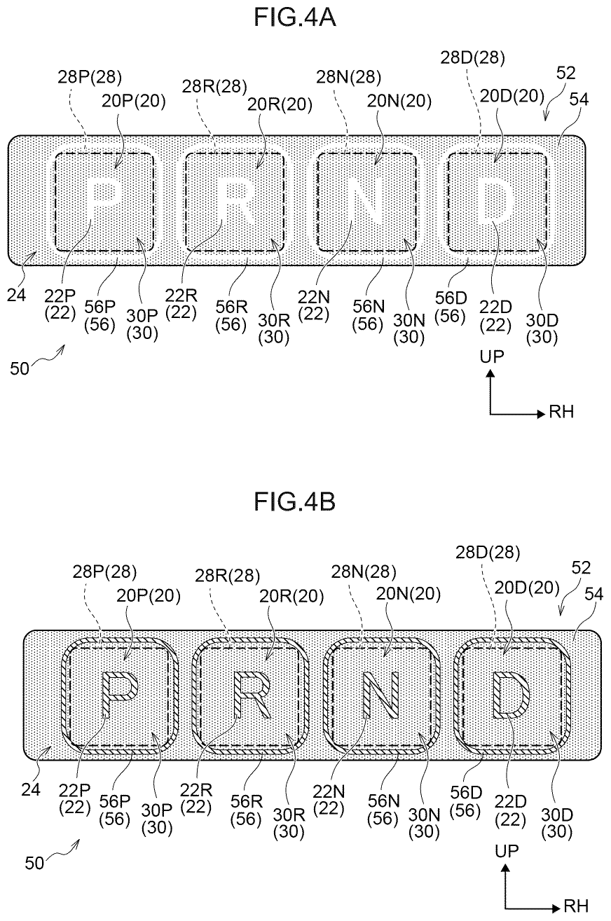

Basic structures of a shifting apparatus 50 according to the second exemplary embodiment are substantially the same as in the shifting apparatus 10 according to the first exemplary embodiment described above. FIG. 4A and FIG. 4B show the shifting apparatus 50 according to the second exemplary embodiment in elevation views seen from the surface side. FIG. 4A shows the shifting apparatus 50 in an illuminated state, and FIG. 4B shows the shifting apparatus 50 in a non-illuminated state.

As shown in FIG. 4A and FIG. 4B, a rectangular plate-shaped shift panel 52 that serves as the selection body and shift selection unit is disposed at the shifting apparatus 50 according to the second exemplary embodiment. The shift panel 52 is employed in the shifting apparatus 50 in place of the shift panel 16.

The shift panel 52 is provided with a plate 54 in place of the plate 18. The marks 24A and 24B indicating the operating region 24 are omitted from the plate 54. Border frames 56 are formed at peripheral edge portions of the regions 30 in the plate 54. Because the marks 24A and 24B are not provided in the shifting apparatus 50, the LEDs 40F on the board 38 may be omitted.

The border frames 56 include a border frame 56P surrounding the P label 22P, a border frame 56R surrounding the R label 22R, a border frame 56N surrounding the N label 22N, and a border frame 56D surrounding the D label 22D. The border frames 56P, 56R, 56N and 56D are formed so as to surround (formed to be a little larger than), respectively, the P electrode 28P, R electrode 28R, N electrode 28N and D electrode 28D. Therefore, in the shift panel 52 (the plate 54), the insides of the border frames 56 form regions corresponding with the electrodes 28 (regions that may detect contact of the occupant finger F). The border frames 56P, 56R, 56N and 56D may be formed so as to be superposed with (to be a similar size to) outer periphery portions of, respectively, the P electrode 28P, R electrode 28R, N electrode 28N and D electrode 28D.

Thus, in the plate 54, the operating region 24 is indicated by all of the border frames 56P, 56R, 56N and 56D, and the P region 30P, R region 30R, N region 30N and D region 30D serving as selection regions are indicated by, respectively, the border frames 56P, 56R, 56N and 56D.

The regions of the border frame 56P, border frame 56R, border frame 56N and border frame 56D of the plate 54 are optically transmissive, similarly to the regions of the labels 22 (the P label 22P, R label 22R, N label 22N and D label 22D). The plate 54 apart from these regions blocks light (is optically non-transmissive).

Therefore, when the shifting apparatus 50 lights up the LED 40P, LED 40R, LED 40N and LED 40D, the P label 22P and border frame 56P, the R label 22R and border frame 56R, the N label 22N and border frame 56N, and the D label 22D and border frame 56D respectively brighten and are clearly shown.

In the shifting apparatus 50 that is structured thus, when the occupant finger F approaches the operating region 24 of the shift panel 52 (the plate 54), the LEDs 40 are lit up and the shift panel 52 (the plate 54) is illuminated from the back side.

In the shifting apparatus 50, when the occupant finger F makes contact with one of the plural regions 30 (the P region 30P, R region 30R, N region 30N or D region 30D) on the shift panel 52 (the plate 54) and selects one of the shift positions 20 (the P position 20P, R position 20R, N position 20N or D position 20D), the transmission control ECU 36 changes the shift range of the transmission 34 to the shift range corresponding to the selected shift position 20.

As shown in FIG. 4B, when the LEDs 40 of the shifting apparatus 50 are not lit, none of the labels 22 and border frames 56 are illuminated and none of the labels 22 and border frames 56 emit light (light is not emitted). Consequently, if the vehicle exterior is dim and the vehicle cabin interior is not bright (is dark), the labels 22 and border frames 56 of the shift panel 52 are hard to see, accurate recognition of the regions 30 may be difficult, and suitable selection of the shift positions 20 may be difficult.

In contrast, as shown in FIG. 4A, when the occupant finger F approaches the shift panel 16 of the shifting apparatus 50 and the LEDs 40 light up, each of the regions 30 in the operating region 24 is illuminated. Consequently, even when the vehicle cabin interior is dark during night or the like, each of the labels 22 of the regions 30 and each of the border frames 56 at the shift panel 52 are brightened, each of the labels 22 and the border frames 56 is clearly shown, and the region 30 of each of the shift positions 20 may be clearly recognized.

When the respective border frames 56 (56P, 56R, 56N and 56D) of the shifting apparatus 50 are brightened (illuminated), the respective regions 30 (the P region 30P, R region 30R, N region 30N and D region 30D) are made clear, and the regions 30 are easy to discern. In consequence, the operating region 24 of the shifting apparatus 10 may be discerned, the shift positions 20 (the P position 20P, R position 20R, N position 20N and D position 20D) may be selected accurately, and mistaken selections of the shift positions 20 may be inhibited effectively.

When the labels 22 (the P label 22P, R label 22R, N label 22N and D label 22D) of the shifting apparatus 50 are illuminated, the shift positions 20 (the P position 20P, R position 20R, N position 20N and D position 20D) are clear. In consequence, in the shifting apparatus 50, the shift positions 20 (the P position 20P, R position 20R, N position 20N and D position 20D) may be selected even more accurately, and mistaken selections of the shift positions 20 may be inhibited even more effectively.

Before the occupant finger F touches the shift panel 52 of the shifting apparatus 50, the shift panel 52 is illuminated from the back side. Therefore, in the shifting apparatus 50, the labels 22 and the border frames 56 are brightened, and the occupant mistakenly touching the regions 30 and mistakenly selecting a shift position may be inhibited effectively. Thus, the shifting apparatus 50 may provide similar effects to the shifting apparatus 10.

The shifting apparatus 50 may light the LEDs 40 beforehand, and the lighting color may be changed when the occupant finger F approaches the shift panel 52, or luminance of the LEDs 40 may be raised (becoming brighter) when the occupant finger F approaches the shift panel 52. In these cases, brightness of the environment of the shift panel 16 (illuminance on the surface side face) may be made a condition and the shifting apparatus 50 may light up the LEDs 40 when the environment is at a predetermined brightness (a brightness in which the labels 22 cannot be distinctly seen in the non-illuminated state, or the like). The shifting apparatus 50 may also light up the LEDs 40 in conjunction with lighting of the front lights of the vehicle. That is, lighting states of the LEDs 40 may be switched between day and night.

The LEDs 40 of the shifting apparatus 50 may be lit such that the region 30 of the shift position 20 that corresponds to the current shift range of the transmission 34 emits light of a different color from the regions of the other shift positions 20. In the shifting apparatus 50, the regions 30 of the shift positions 20 that correspond to shift ranges to which the transmission 34 can be changed and the regions 30 of the shift positions 20 that correspond to shift ranges to which the transmission 34 cannot be changed may be illuminated with different colors or brightnesses.

The border frames 56 and labels 22 of the regions 30 may be configured to be illuminated with different colors, brightnesses and timings. In this configuration, for example, the border frames 56 may be illuminated prior to the labels 22. Further, the border frames 56 and labels 22 of the regions 30 may be illuminated with different brightnesses and colors or the like, such as the border frames 56 being illuminated in a dark color and the labels 22 being illuminated in a more vivid color, or the like.

### Third Exemplary Embodiment

Now, a third exemplary embodiment is described.

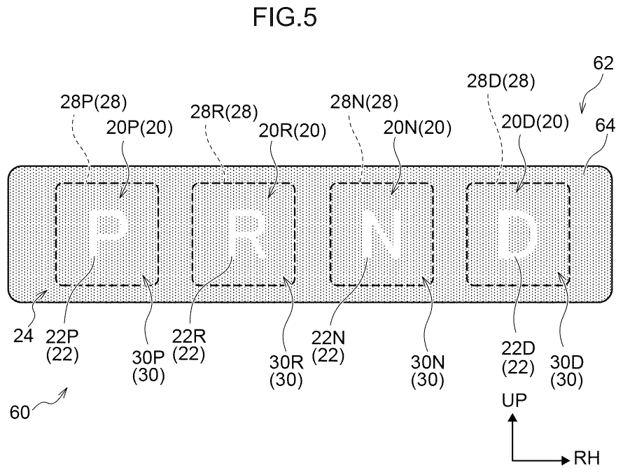

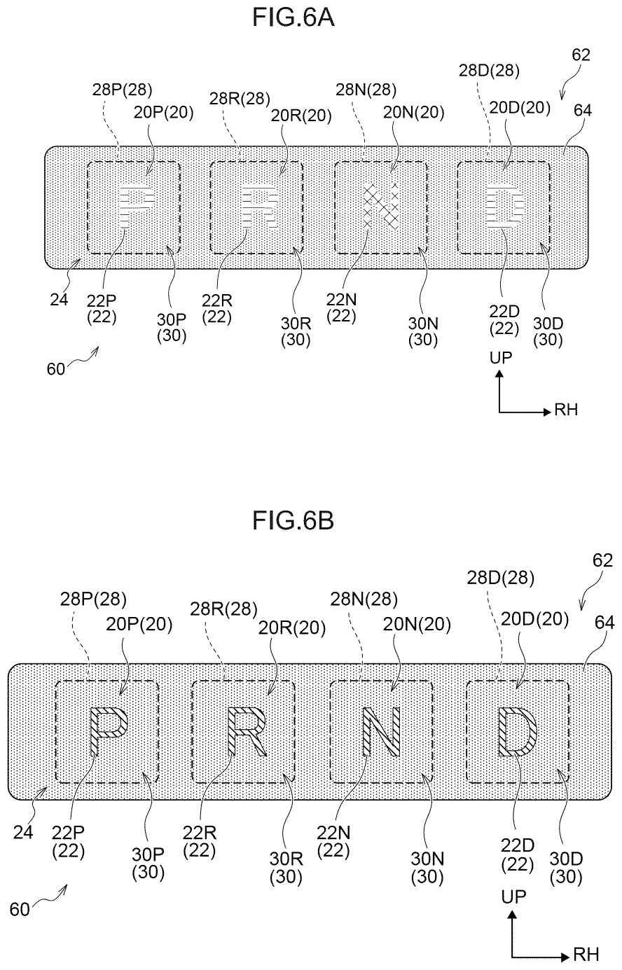

Basic structures of a shifting apparatus 60 according to the third exemplary embodiment are substantially the same as in the shifting apparatus 10 according to the first exemplary embodiment and the shifting apparatus 50 according to the second exemplary embodiment described above. FIG. 5, FIG. 6A and FIG. 6B show the shifting apparatus 60 according to the third exemplary embodiment in elevation views seen from the surface side. FIG. 6A shows the shifting apparatus 60 in an illuminated state, and FIG. 6B shows the shifting apparatus 60 in a non-illuminated state.

As shown in FIG. 5, a rectangular plate-shaped shift panel 62 that serves as the selection body and shift selection unit is disposed at the shifting apparatus 60 according to the third exemplary embodiment. The shift panel 62 is employed in the shifting apparatus 60 in place of the shift panel 16 or 52.

The shift panel 62 is provided with a plate 64 in place of the plate 18 or 54. The marks 24A and 24B indicating the operating region 24 and the border frames 56 are omitted from the plate 64.

Accordingly, the labels 22 (the P label 22P, R label 22R, N label 22N and D label 22D) are formed at the regions 30 (the P region 30P, R region 30R, N region 30N and D region 30D) of the plate 64.

The shifting apparatus 60 causes the LEDs 40 to emit light with different colors when the occupant finger F is approaching the shift panel 62 (the plate 64) and when the occupant finger F touches one of the regions 30 at the shift panel 62 (the plate 64) and that shift position 20 is selected.

In the shifting apparatus 60 that is structured thus, when the occupant finger F approaches the operating region 24 of the shift panel 62 (the plate 64), the LEDs 40 light up and the shift panel 62 (the plate 64) is illuminated from the back side. When the occupant finger F makes contact with the regions 30, the shifting apparatus 60 changes the color illuminating the shift panel 62 (the plate 64). In the shifting apparatus 60, when the occupant finger F makes contact with one of the plural regions 30 and selects that shift position 20, the transmission control ECU 36 changes the shift range of the transmission 34 to the shift range corresponding to the selected shift position 20.

As shown in FIG. 6B, when the LEDs 40 of the shifting apparatus 60 are not lit, none of the labels 22 are illuminated (the labels 22 are not bright). Consequently if the vehicle cabin interior is dim, the labels 22 of the shift panel 62 are hard to see, accurate recognition of the regions 30 may be difficult, and suitable selection of the shift positions 20 may be difficult.

In contrast, when the occupant finger F approaches the shift panel 62 of the shifting apparatus 60 and the LEDs 40 light up (for example, lighting up in white), the labels 22 of the regions 30 in the operating region 24 are illuminated. Consequently, even when the vehicle cabin interior is dark during night or the like, the shifting apparatus 60 makes the regions 30 that the occupant finger F touches clear, and the shift positions 20 may be suitably recognized.

As illustrated in FIG. 6A, when the occupant finger F touches one of the regions 30 of the shift panel 62, the shifting apparatus 60 causes the LED 40 corresponding to the region 30 that is touched to light up in a different color from the LEDs 40 corresponding to the other regions 30. FIG. 6A depicts a state in which the occupant finger F is in contact with the N region 30N, the LED 40N is lit up in orange (a warm color), and the LED 40P, LED 40R and LED 40D are lit up in blue (a cold color).

The shifting apparatus 60 that is structured thus may provide the same effects as the shifting apparatus 10 according to the first exemplary embodiment and the shifting apparatus 50 according to the second exemplary embodiment. In addition, the shifting apparatus 60 may make clear the shift position 20 that is selected by the occupant (and each shift position 20 that is not selected by the occupant).

In the shifting apparatus 60, colors of the labels 22 are made different by the LED 40 of the region 30 that the occupant finger F touches lighting up in orange and the LEDs of the other regions 30 lighting up in blue. Alternatively, the brightness (luminance) of the LED 40 of the region 30 that the occupant finger F touches may be made brighter than the brightnesses of the LEDs 40 of the other regions 30, or the brightness (luminance) of the LED 40 of the region 30 that the occupant finger F touches may be made darker than the brightnesses of the LEDs 40 of the other regions 30.

The LEDs 40 of the shifting apparatus 60 may be lit such that the region 30 of the shift position 20 that corresponds to the current shift range of the transmission 34 emits light of a different color or brightness from the regions of the other shift positions 20. In the shifting apparatus 60, the LEDs 40 may be lit such that the regions 30 of the shift positions 20 that correspond to shift ranges to which the transmission 34 can be changed and the regions 30 of the shift positions 20 that correspond to shift ranges to which the transmission 34 cannot be changed are illuminated with different colors or brightnesses.

Brightness of the environment (illuminance on the surface side face) of the shift panel 62 of the shifting apparatus 60 may be made a condition and the LEDs 40 may be lit up when the environment is at a predetermined brightness (a brightness in which the labels 22 cannot be distinctly seen in the non-illuminated state, or the like). The LEDs 40 may also be lit in conjunction with lighting of the front lights of the vehicle.

Similarly to the shifting apparatus 10 and the shifting apparatus 50, the shifting apparatus 60 may change lighting colors of the LEDs 40, such as lighting the LEDs 40 beforehand in a dark color such as deep green or the like and lighting the LEDs 40 in a more vivid color such as yellow or orange when the occupant finger F approaches the shift panel 62, or the like. The LEDs 40 may be lit beforehand with a low luminance (brightness), and may be lit up such that the luminance is higher (brighter) when the occupant finger F approaches the shift panel 16.

The LEDs 40 of the shifting apparatus 60 may be lit such that the region 30 of the shift position 20 that corresponds to the current shift range of the transmission 34 emits light of a different color from the regions of the other shift positions 20. In the shifting apparatus 50, the regions 30 of the shift positions 20 that correspond to shift ranges to which the transmission 34 can be changed and the regions 30 of the shift positions 20 that correspond to shift ranges to which the transmission 34 cannot be changed may be illuminated with different colors or brightnesses.

The operating region that an operating part is to touch may be provided with protruding portions or recessed portions to enable recognition of the operating regions or the respective selection regions.

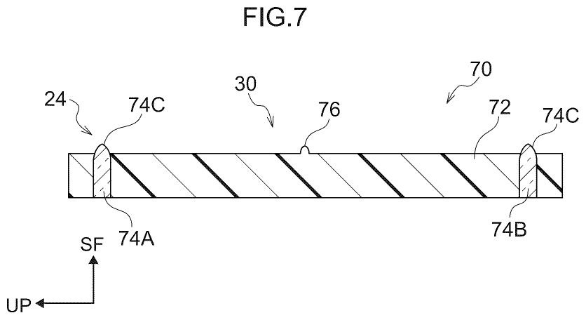

FIG. 7 shows a shift panel 70 that serves as the selection body and shift selection unit formed in a shape that enables recognition of the operating region 24 at the surface and the regions 30 that serve as selection regions. The shift panel 70 may be used in place of the shift panel 16 of the shifting apparatus 10, the shift panel 52 of the shifting apparatus 50 or the shift panel 62 of the shifting apparatus 60. FIG. 7 shows principal portions of the shift panel 70 in a sectional diagram viewed from one side in the left-and-right direction. The electrode sheet 26 at which the electrodes 28 are disposed is omitted from FIG. 7.

As illustrated in FIG. 7, at a plate 72 of the shift panel 70, a mark 74A is formed at the upper side of the operating region 24 and a mark 74B is formed at the lower side. The labels 22 indicating the shift positions 20 (not shown in FIG. 7) are formed at the plate 72 in the regions 30 between the marks 74A and 74B.

The marks 74A and 74B are optically transmissive. The marks 74A and 74B are formed as projecting portions 74C of which the surface sides project in substantially circular shapes in cross section. A protrusion portion 76 in a hemispherical shape is formed at the plate 72 in a central portion of the regions 30. Projection heights of the projecting portions 74C of the marks 74A and 74B and the protrusion portion 76 are preferably heights that may inhibit the adherence of dust, grease and the like, and with which the occupant finger F may sense the presence of the marks 74A and 74B and the protrusion portion 76 without causing discomfort when touched. For example, the projection heights are in a range from several tenths of a mm to 2 mm.

In the shift panel 70 (the plate 72) that is structured thus, light emitted from the back side face is transmitted through the marks 74A and 74B and is polarized at tip portions of the marks 74A and 74B. Thus, the operating region 24 between the marks 74A and 74B is brightened and the regions 30 are clearly shown. Because the projecting portions 74C of the marks 74A and 74B project from the surface side face of the plate 72, light transmitted through the marks 74A and 74B is polarized and dispersed. Thus, even though widths of the marks 74A and 74B are narrow, the operating region 24 and the regions 30 may be clearly seen.

When the occupant finger F makes contact with the regions 30, the occupant finger F may be assuredly guided in the regions 30 by the marks 74A and 74B, and the central position of the regions 30 may be easily discerned from the protrusion portion 76. Therefore, the occupant mistakenly selecting the shift positions 20 may be inhibited even more effectively. In addition, because the marks 74A and 74B and protrusion portion 76 of the shift panel 70 are formed to project, appearance may be good and design may be improved.

It is sufficient to provide one or more of the projecting portions 74C at the marks 74A and 74B and of the protrusion portion 76. Furthermore, the marks 74A and 74B may be provided as slot-shape recess portions instead of the projecting portions 74C, a hemispherical recess portion may be provided instead of the protrusion portion 76, and the labels 22 may be formed to project.

The disclosures of Japanese Patent Application No. 2022-112621 filed Jul. 13, 2022 are incorporated into the present specification by reference in their entirety.

All references, patent applications and technical specifications cited in the present specification are incorporated by reference into the present specification to the same extent as if the individual references, patent applications and technical specifications were specifically and individually recited as being incorporated by reference.

1. A shifting apparatus, comprising:
a shift selection unit that enables selection of respective shift positions by contact of an operating part, a plurality of selection regions being disposed in an operating region of the shift selection unit, and a shift range of a transmission of a vehicle being changed when the operating part makes contact with the operating region and selects one of the shift positions; and
an illumination means that, when the operating part makes contact with the operating region, illuminates the operating region and clearly shows the selection regions.

2. The shifting apparatus according to claim 1, wherein the illumination means illuminates at least a portion of an outer periphery portion of the operating region and clearly shows the selection regions.

3. The shifting apparatus according to claim 1, wherein the illumination means illuminates outer periphery portions of the selection regions and clearly shows the selection regions.

4. The shifting apparatus according to claim 1, wherein:
symbols respectively indicating the shift positions are disposed in the respective selection regions, and
the illumination means illuminates the symbols and clearly shows the selection regions.

5. The shifting apparatus according to claim 1, wherein the illumination means clearly shows, among the plurality of selection regions, a selection region that the operating part is approaching.

6. The shifting apparatus according to claim 1, wherein the illumination means varies an illumination state between, among the plurality of selection regions,
a selection region corresponding to a shift range prior to a change of the transmission, and
a selection region corresponding to a different shift range from that shift range.

7. The shifting apparatus according to claim 1, wherein the illumination means illuminates a selection region corresponding to a shift range to which the transmission can be changed.

8. The shifting apparatus according to claim 1, wherein the illumination means illuminates the selection regions when the operating part is in contact with the selection regions.
